(19) United States
(12) Patent Application Publication
(10) Pub. No.: US 2007/0006463 A1
(43) Pub. Date: Jan. 11, 2007

(54) Integrated wet shaving and trimming implement

(75) Inventor: Andrew Pennella, Stamford, CT (US)

Correspondence Address: MICHAUD-DUFFY GROUP LLP, 306 INDUSTRIAL PARK ROAD, SUITE 206, MIDDLETOWN, CT, 06457, US

(73) Assignee: Eveready Battery Company, Inc., St. Louis, MO (US)

(21) Appl. No.: 11/480,726

(22) Filed: Jul. 3, 2006

Related U.S. Application Data
(60) Provisional application No. 60/697,461, filed on Jul. 7, 2005.

(51) Int. Cl. B26B 21/00

(52) U.S. Cl. 30/34.1; 30/47; 30/50

(57) ABSTRACT

An integrated wet shaving and precision trimming implement includes a handle; a razor cartridge attached thereto; and a trimming tool removably located in the handle. The trimming tool is configured for trimming hair at an edge of a hirsute area. A trimming implement for use during a shaving operation is insertable into a chamber defined by a razor handle and includes a shaft; a blade attached to the shaft; a comb attached over the blade; and a cap attached to an end of the shaft. The cap is receivable on the razor handle to retain the trimming implement in the chamber defined by the razor handle. A trimmer integrated with a handle of a shaving implement includes a reciprocatingly mounted blade and a comb mounted over the blade. The blade is capable of operating in a reciprocating motion via any suitable power source.

### CROSS REFERENCE TO RELATED APPLICATIONS

This application is entitled to the benefit of and incorporates by reference the disclosure of U.S. patent application No. 60/697,461 filed on Jul. 7, 2005 entitled “Integrated Wet Shaving And Trimming Implement.”

### TECHNICAL FIELD

The present invention relates generally to shaving implements and, more particularly, to implements adapted to both wet shaving and precision trimming of hirsute areas.

### BACKGROUND OF THE INVENTION

In conventional wet shaving systems, a razor includes a handle and a shaving head. The shaving head, which may be either unitary with the handle or separable thereform, includes a replaceable cartridge that houses one or more razor blades and includes a guard positioned forward of the cutting edges of the razor blades and a cap positioned aft of the cutting edges of the razor blades. The razor cartridge operates to maintain the blade edge(s) at a predetermined spacing and angle relative to the skin surface. The guard portion operates to stretch the skin in front of the razor blades in preparation for the shaving operation.

While conventional wet shaving systems are suitable for removing hair growing close to the surface of the skin, such systems are often inadequate for grooming or trimming hair of relatively longer length such as, for example, side burns, beards, mustaches, goatees, soul patches, and the like for men and legs, underarms, bikini areas, and the like for women. Edges and contours, particularly along the jawbone or in the underarms, are especially difficult to trim and maintain as the size of the razor cartridge increases. Given the difficulty associated with shaving such areas, separate wet shaving and trimming systems are often used to accomplish complete grooming of both short and long hair of hirsute areas.

As can be appreciated, however, maintaining multiple items for use in shaving and trimming operations poses an inconvenience. Stowing a separate trimming apparatus in addition to stowing a shaving device generally adds time to the overall shaving process. Additionally, having to pack and store multiple implements in preparation for or when traveling provides ample opportunity for forgetting or losing items, which in turn adds undue stress to the trip.

What is needed is an integrated wet shaving and precision trimming implement that provides a single solution to personal grooming needs for both men and women.

### SUMMARY OF THE PRESENT INVENTION

In one aspect, the present invention is directed to an integrated wet shaving and precision trimming implement. The implement includes a handle; a razor cartridge attached to the handle; and a trimming tool removably located in the handle. The razor cartridge has one or more razor blades, a cap, and a guard, each of the one or more razor blades including a cutting edge positioned contiguous with a shave plane. The trimming tool, which is selectively removable at the behest of the user, is configured for trimming hair at an edge of a hirsute area.

In another aspect, the present invention is directed to a trimming implement for use during a shaving operation. The trimming implement is insertable into a chamber defined by a razor handle (e.g., into the end of the razor handle). The trimming implement includes a shaft; a blade attached to the shaft along a length thereof; a comb attached over the blade; and a cap attached to an end of the shaft. The cap is receivable on the razor handle to retain the trimming implement in the chamber defined by the razor handle. For example, the cap may be receivable in the open end of the razor handle in a friction fit.

In still another aspect, the present invention is directed to a trimmer integrated with a handle of a shaving implement. The trimmer includes a reciprocatingly mounted blade and a comb mounted over the blade. The blade is capable of operating in a reciprocating motion via any suitable power source (e.g., a battery or alternating current). The comb, which may be removably positioned over the reciprocating blade, allows hair to be aligned to facilitate the trimming operation. Additionally, the comb may space the reciprocating blade from the skin to allow hair (such as the eyebrows) to be trimmed down to a particular length.

In using the trimming wand, more precise edging of relatively longer length hair (e.g., side burns, beards, mustaches, goatees, soul patches, and the like for men and legs, underarms, bikini areas, and the like for women) can be achieved as compared to the razor blades of the cartridge. In particular, the ability to maneuver the blade of the trimming wand to execute a cutting motion normal to the skin surface along the desired line of trim allows cleaner edging lines to be made at the defining border that separates clean-shaven skin from hair.

Another advantage is that integration of the trimming wand into the handle supporting the wet shaving cartridge provides a convenience for the user. More specifically, the integration of both the wet shaving device and the trimming tool into one implement means that both tools are readily available when a trimming operation is necessary.

### BRIEF DESCRIPTION OF THE DRAWINGS

FIG. 1 is a perspective view of one embodiment of a wet shaving implement of the present invention having an integrated trimming device.

FIG. 2 is an exploded perspective view of the wet shaving implement and integrated trimming device of FIG. 1.

FIG. 3 is a perspective view of another embodiment of a wet shaving implement of the present invention having an integrated trimming device.

FIG. 4 is a perspective view of the wet shaving implement of FIG. 3 in which the integrated trimming device is deployed.

FIG. 5 is a perspective view of another embodiment of a wet shaving implement of the present invention having a reciprocating blade as an integrated trimming device.

FIG. 6 is a perspective view of a reciprocating blade of the wet shaving implement of the present invention having two reciprocating blades and combs extending thereover.

FIG. 7 is a side view of another embodiment of a wet shaving implement of the present invention having two razor head portions.

FIG. 8 is a perspective view of a trimming device of the implement of FIG. 7.

FIG. 9 is a perspective view of a rotary trimming device of the present invention.

FIG. 10 is a perspective view of another embodiment of a wet shaving implement of the present invention.

FIG. 11 is an exploded perspective view of a trimming device of the wet shaving implement of FIG. 10.

### DETAILED DESCRIPTION OF THE PREFERRED EMBODIMENT

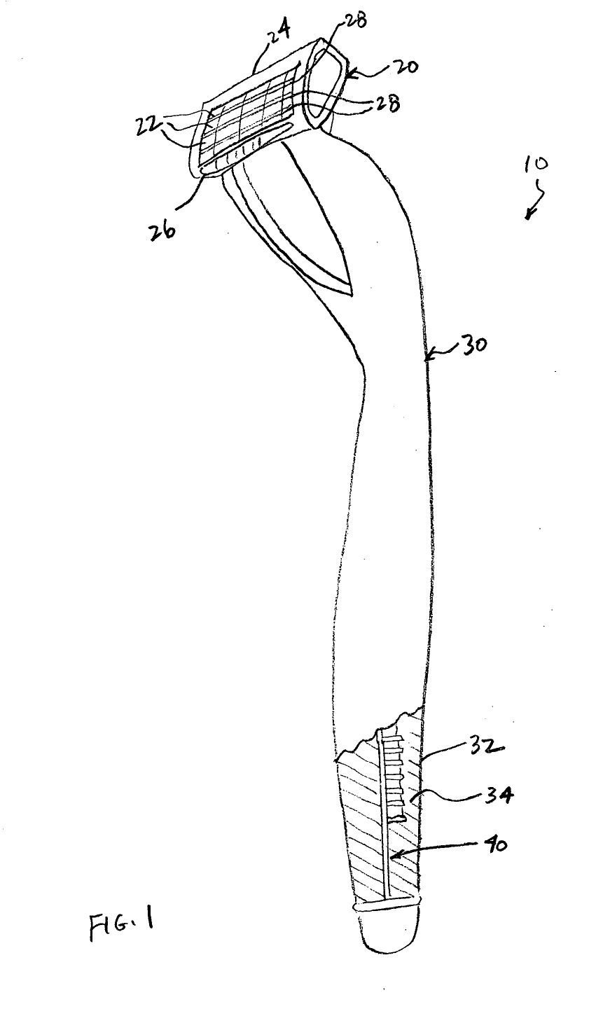

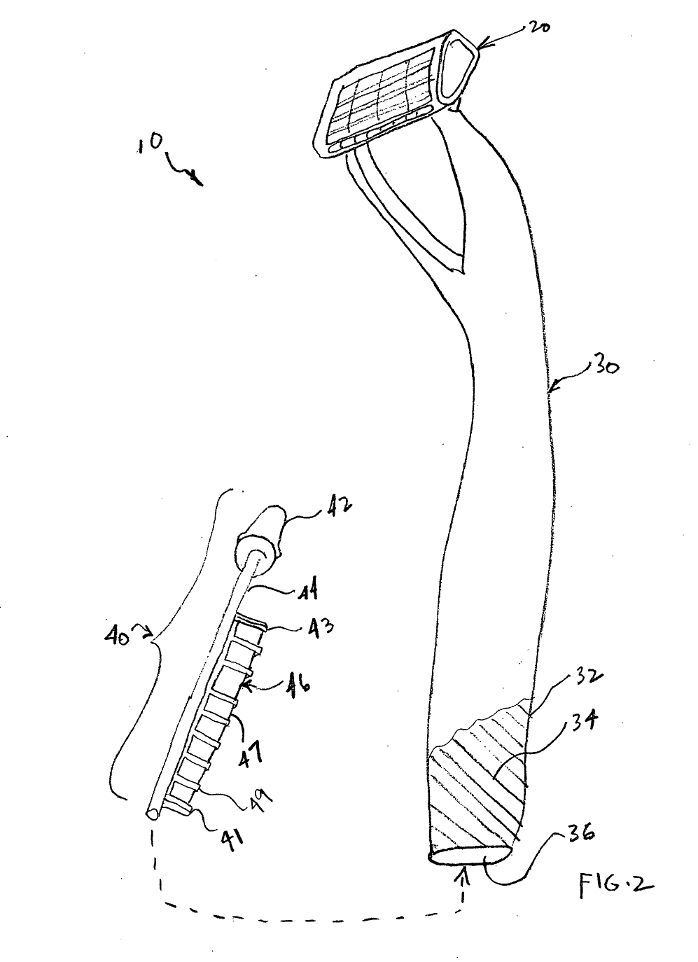

Referring to FIGS. 1 and 2, one exemplary embodiment of a wet shaving implement having an integrated trimming device of the present invention is shown generally at 10 and is hereinafter referred to as “implement 10.” The implement 10 includes a razor cartridge 20, a handle 30 to which the razor cartridge is attached, and a trimming wand 40 removably located in the handle. The razor cartridge 20, which is particularly suited for wet shaving operations in which hairs growing close to the surface of the skin are to be removed, includes one or more razor blades 22 mounted forward of a cap 24 and aft of a guard 26. Each of the one or more razor blades 22 includes a cutting edge 28 that extends lengthwise along an edge of the razor blade. Each razor blade 22 is also positioned to be substantially contiguous with a shave plane. As used herein, the term “shave plane” is defined as a theoretical plane extending tangentially from the uppermost surface of the cap 24 to the uppermost surface of the guard 26 and outwardly therefrom in all directions.

Referring specifically to FIG. 2, at least a portion of the handle 30 is a housing 32 that defines an interior chamber 34 open at an end 36 of the handle opposite the end at which the razor cartridge 20 is attached. The interior chamber 34 receives and stores the trimming wand 40 when not in use. The trimming wand 40 includes a shaft 44, a cap 42 positioned at one end of the shaft, and a blade 46 extending along at least a portion of the shaft. The blade 46 has a cutting edge 47. A comb 49 is mounted integral with the shaft 44 such that teeth of the comb extend over the cutting edge 47 of the blade 46. A first guard 41 may be disposed at one end of the blade 46, and a second guard 43 may be disposed at the opposing end of the blade. When not in use, the trimming wand 40 is stored within the interior chamber 34 where it is held in a readily available position. When the trimming wand 40 is inserted into the interior chamber 34, the cap 42 is received into the open end 36 of the handle 30 and retained therein in a friction fit. When it is desired to trim the hair at the edge of a hirsute area, the trimming wand 40 is retrieved from the interior chamber 34 by grasping the cap 42 and pulling the trimming wand from its stored position within the handle 30.

The blade 46 of the trimming wand 40 is utilized to provide a cutting motion along the desired trim line, for example, by dragging the blade along the trim line to sever hairs that errantly extend over the trim line or by pressing the blade 46 into the skin to sever the hairs as they are trapped between the cutting edge 47 and the skin surface. Such motions are in contrast to the cutting of shorter hairs by the razor blades of the razor cartridge, which is dragged or pushed across the skin surface such that the cutting edges of the razor blades engage hairs along the entire lengths thereof to provide cutting effects in the shave plane.

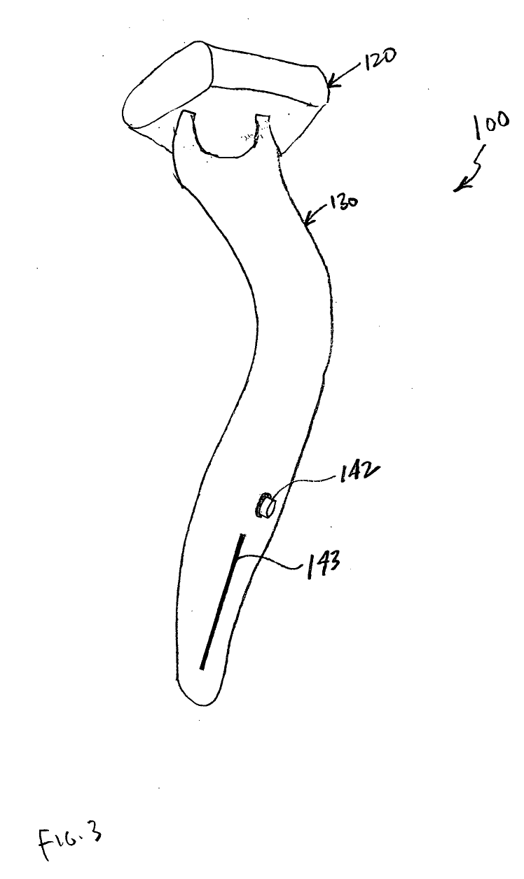

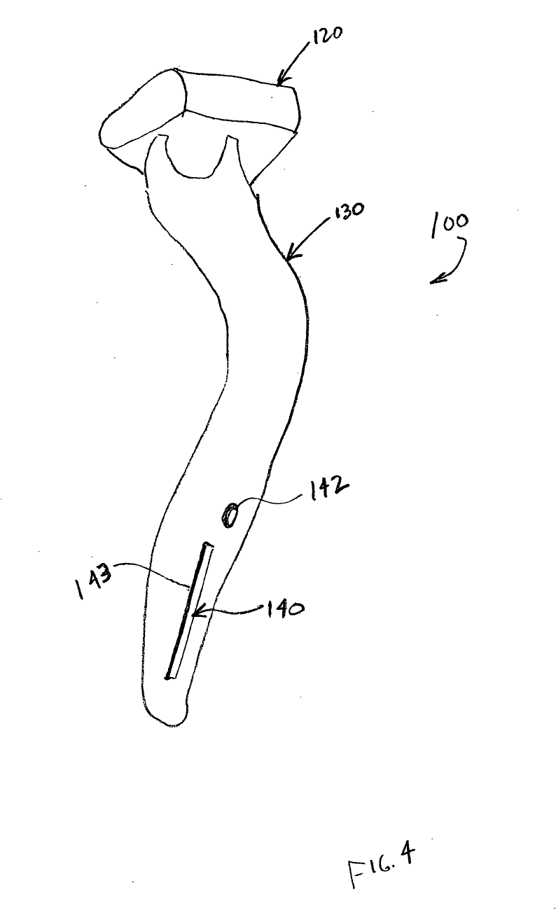

Referring now to FIGS. 3 and 4, another exemplary embodiment of an integrated wet shaving and precision trimming implement of the present invention is shown at 100 and includes a razor cartridge 120, a handle 130 to which the razor cartridge is attached, and a spring-operated, selectively deployable trimming blade 140 mounted in the handle. When the trimming blade 140 is not in use, it is stored in an interior chamber defined by the handle 130. When the user desires to utilize the trimming blade 140, it is deployed from the handle 130.

A spring and latch mechanism is used to selectively deploy the trimming blade 140 from the handle 130. The spring and latch mechanism, which is positioned in the interior chamber defined by the handle 130, is cooperably connected to both the trimming blade 140 and an actuator. The actuator may be a switch or a button 142, as shown, although the present invention is not limited in this regard as other devices can be used as actuators to deploy the trimming blade 140.

The spring and latch mechanism is disposed in the handle 130 such that the spring biases the trimming blade 140 in a direction out of the handle through an opening such as a slit 143. The latch is connected to either the spring or the trimming blade 140 and further to the button 142. The latch impedes the action of the spring or the movement of the trimming blade 140 out of the handle 130. When the button 142 is pressed, the latch is disengaged from either the spring or the trimming blade 140, and the trimming blade is released to extend through the slit 143. In the deployed position, the trimming blade 140 extends from the handle 130 such that when the user grasps the handle, the trimming blade can be maneuvered to cut hair along a trim edge of a hirsute area.

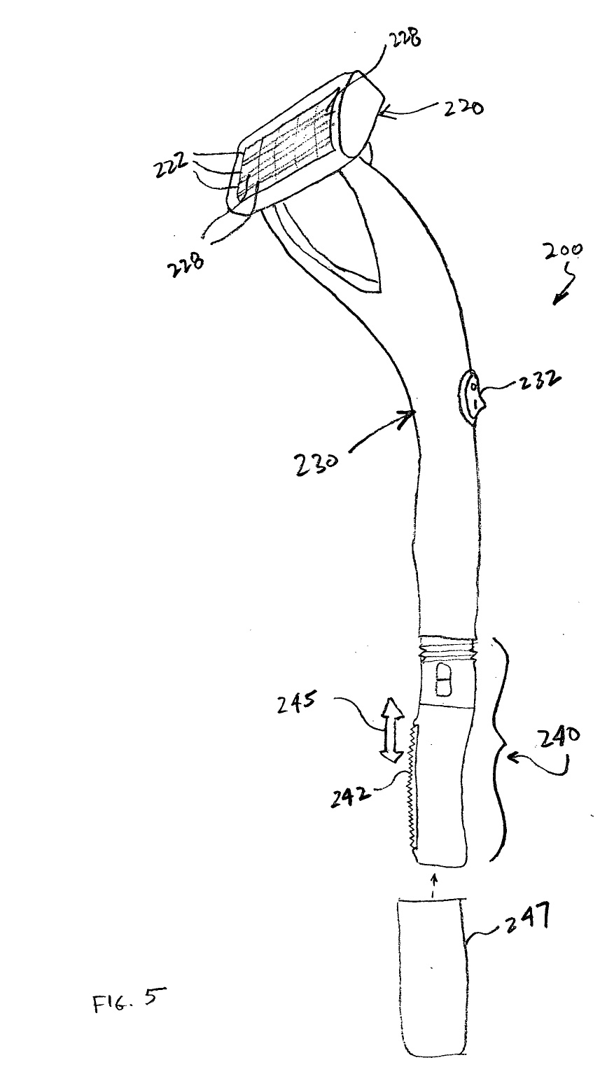

Referring now to FIG. 5, another exemplary embodiment of an integrated wet shaving and precision trimming implement of the present invention is shown at 200 and includes a razor cartridge 220, a handle 230 to which the razor cartridge is attached, and a trimmer 240 operably attached to the handle. As with the aforementioned implements, the razor cartridge 220 is particularly suited for wet shaving operations and includes one or more razor blades 222 having cutting edges 228 contiguous with the shave plane.

The trimmer 240 includes at least one reciprocating blade 242, which moves in alternating opposing directions indicated by an arrow 245. Preferably, two reciprocating blades 242 move in coordination to sever hairs as they are trapped between the teeth of one reciprocating blade 242 as it moves in a direction that is opposite the direction in which another reciprocating blade moves. The motions of the reciprocating blades 242 are effected via a battery operably connected to any mechanism suitable for causing the reciprocating motion. The portion of the trimmer 240 on which the reciprocating blades 242 are mounted is releasable from the handle 230 via a latch 251 to allow for the insertion of the battery into a receptacle in the handle. The present invention is not limited to being battery-powered, however, and other methods of powering the reciprocating blades (e.g., alternating current) are within the scope of the invention. A switch 232 or other device is disposed on the handle 230 to actuate the trimmer 240. A cover 247 may be removably positioned over the trimmer 240 and threadedly received onto the handle 230.

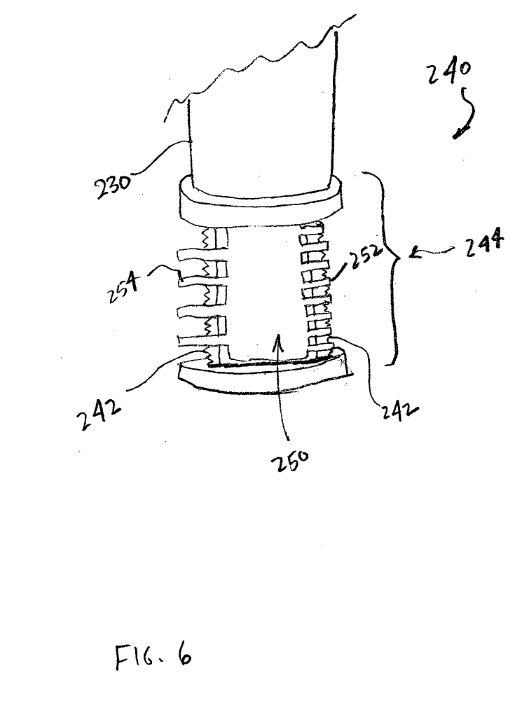

The trimmer 240 may be fitted with one or more accessories to expand the performance and capability of the trimmer. Referring now to FIG. 6, the trimmer 240 may include a head 244 integrally mounted at the handle 230. The head 244 includes the reciprocating blade 242 (two sets of reciprocating blades are shown) mounted therein. A shaping comb 250 is positioned over the reciprocating blades 242. In embodiments in which two sets of reciprocating blades 242 are utilized, the shaping comb 250, which may be fixedly or removably mounted, includes a short hair comb 252 and a long hair comb 254, the short hair comb 252 cooperating with one set of reciprocating blades to cut and shape shorter facial hair (e.g., the eyebrows) and the long hair comb 254 cooperating with the other set of blades to cut and shape longer facial hair (e.g., beards, mustaches, etc.)

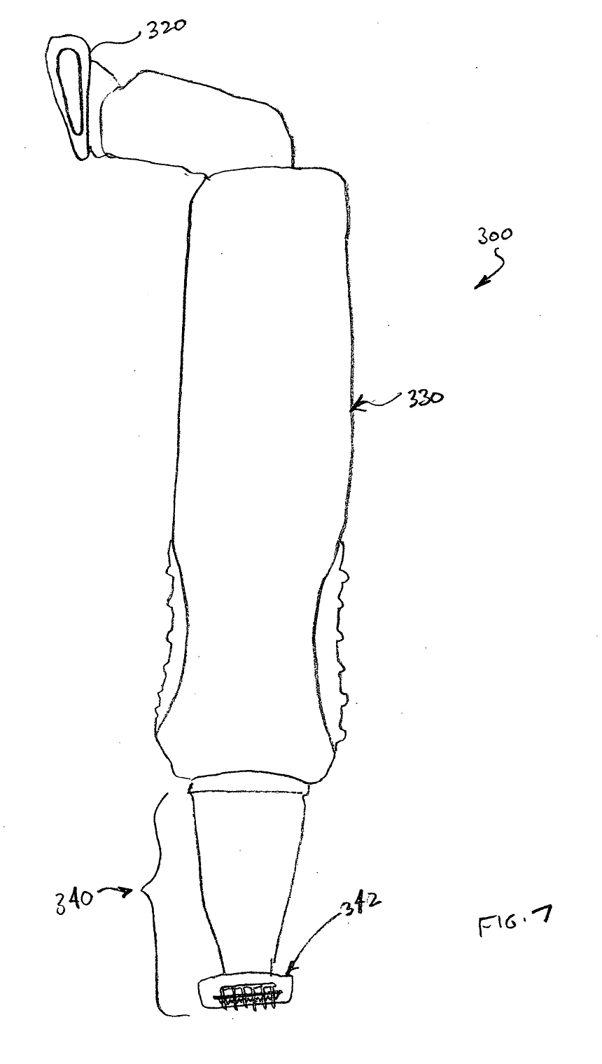

Referring now to FIG. 7, another exemplary embodiment of an integrated wet shaving and precision trimming implement of the present invention is shown at 300 and is referred to as “implement 300.” The implement 300 includes an ergonomic handle 330 to facilitate control of the implement during a shaving operation, particularly when shaving difficult-to-access areas such as underarms and ankles. The implement 300 also includes two head portions, a first head portion having a razor cartridge 320 positioned at a first end of the handle 330 and a second head portion embodying a trimmer 340 positioned at a second end of the handle. The first head portion may be fixedly mounted on the handle 330, or it may be pivotally mounted on the handle. The razor cartridge 320 is suited for wet shaving operations and includes one or more razor blades having cutting edges contiguous with the shave plane.

The trimmer 340 positioned on the opposing end of the handle 330 includes a trimming head 342 in which combs and blades are cooperably mounted for use in trimming operations. The combs may be short hair combs and/or long hair combs as described above. The blades are operably connected to a power source (e.g., a battery mounted within the handle 330).

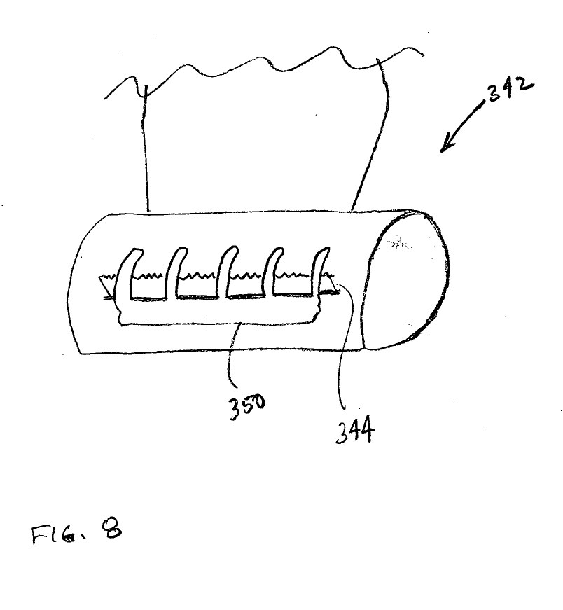

Referring now to FIG. 8, the trimming head 342 may include an integrated arrangement of at least one reciprocating blade 344 and an adjacently-positioned comb 350. As shown, the teeth of the comb 350 extend over the reciprocating blades 344 such that when the head portion 342 is dragged through hair to be trimmed, the teeth of the comb align the hairs for subsequent trimming by the reciprocating blades.

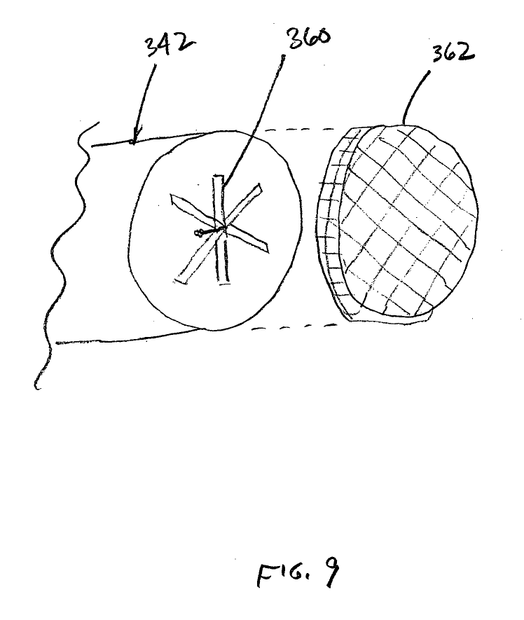

Referring now to FIG. 9, the trimming head may additionally or alternately include a rotating blade 360. The rotating blade 360 is shown as being positioned at an end of the trimming head 342, although the present invention is not limited in this regard and the rotating blade may be positioned anywhere along the length of the trimming head. A grate, filter, or comb 362 may be positioned over the rotating blade 360 to align hairs for trimming and to prevent inadvertent contact with the blade. The comb 362 may be fixed in place or configured to “float” over the rotating blade 360 to accommodate undulations and contours in the skin surface. As with previous embodiments, the blade 360 may be rotatable via battery power or any other suitable means.

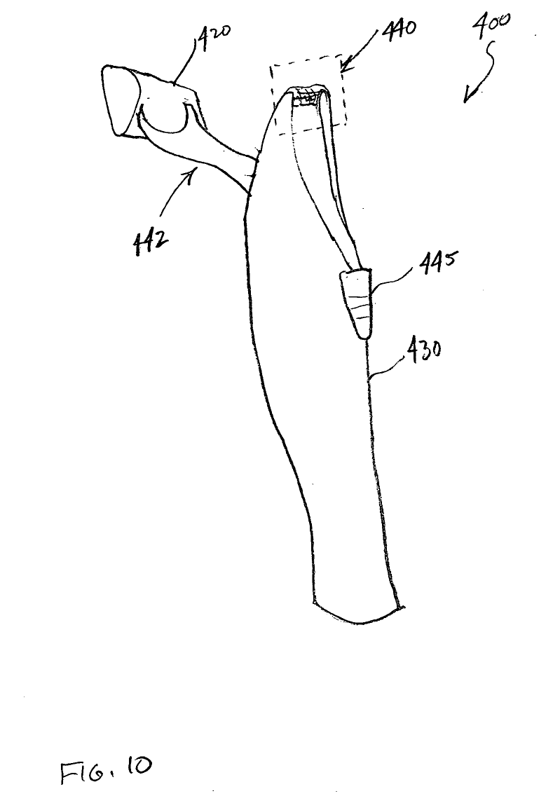

Referring now to FIG. 10, another exemplary embodiment of an integrated wet shaving and precision trimming implement of the present invention is shown at 400 and is referred to as “implement 400.” The implement 400 includes an ergonomic handle 430 to facilitate control of the implement during a shaving operation. A head portion 442 is pivotally mounted on the handle 430 proximate one end thereof. As in previously disclosed embodiments, the head portion 442 includes a razor cartridge 420 suited for wet shaving operations and includes one or more razor blades having cutting edges contiguous with the shave plane.

The implement 400 also includes a trimmer 440 positioned at or adjacent an end of the handle 430 at which the head portion 442 is mounted. Accordingly, both the head portion 442 and the trimmer 440 are positioned substantially at the same end of the handle 430, which thereby allows the opposing end of the handle to be unobstructed for grasping by the user. A switch 445 allows for the selective operation of the trimmer 440.

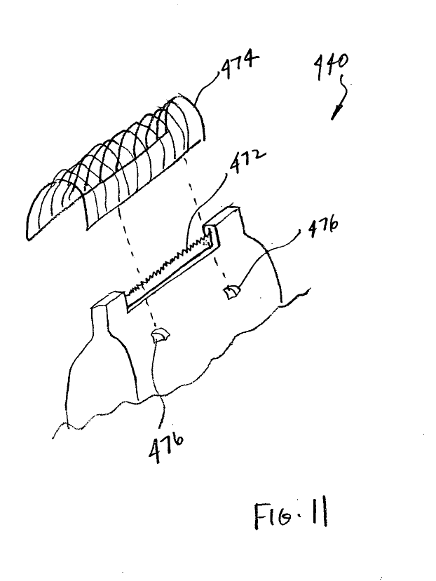

Referring now to FIG. 11, the trimmer 440 includes at least one reciprocating blade 472 configured to trim hair. The blade 472 may be made to move in a reciprocating motion via battery power or any other suitable means. A comb 474 may be received over the reciprocating blade 472 and retained thereon in a frictional fit by deflectable tabs 476 or the like. The teeth of the comb 474 are spaced from each other and arranged such that when the trimmer 440 is dragged through the hairs, the hairs are aligned in preparation for being trimmed.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the scope of the present invention as defined by the appended claims.

What is claimed is:

1. An integrated wet shaving and precision trimming implement, comprising:
a handle;
a razor cartridge attached to said handle, said razor cartridge having one or more razor blades, a cap, and a guard, each of the one or more razor blades including a cutting edge positioned contiguous with a shave plane; and
a trimming tool removably located in said handle, said trimming tool being configured for trimming hair at an edge of a hirsute area.

2. The integrated shaving and trimming implement of claim 1, wherein said-handle defines a housing defining an interior chamber open at one end of said handle from which said trimming tool can be selectively removed and inserted.

3. The integrated shaving and trimming implement of claim 1, said trimming tool comprising,
a shaft,
a blade attached to said shaft along a length thereof,
a comb attached over said blade, and
a cap attached to an end of said shaft.

4. The integrated shaving and trimming implement of claim 3, wherein said cap is received on an open end of said handle in which said trimming tool is positioned, said cap being configured to retain said trimming tool in said handle.

5. The integrated shaving and trimming implement of claim 1, wherein said trimming tool is selectively deployable to extend from a surface of said handle.

6. The integrated shaving and trimming implement of claim 1, wherein said trimming tool comprises a reciprocating blade.

7. The integrated shaving and trimming implement of claim 6, wherein said reciprocating blade is operably connected to a power source to provide reciprocating motion.

8. The integrated shaving and trimming implement of claim 6, further comprising a shaping comb positioned over said reciprocating blade.

9. The integrated shaving and trimming implement of claim 8, wherein said shaping comb comprises at least one of a long hair comb and a short hair comb, each of said combs being configured to direct hairs to said reciprocating blade.

10. The integrated shaving and trimming implement of claim 1, wherein said handle is ergonomically-shaped.

11. A trimming implement insertable into a chamber defined by a razor handle, said trimming implement comprising:
a shaft;
a blade attached to said shaft along a length thereof;
a comb attached over said blade; and
a cap attached to an end of said shaft, said cap being receivable on said razor handle to retain said trimming implement in said chamber defined by said razor handle.

12. The trimming implement of claim 11, wherein said cap is receivable on said razor handle in a frictional fit.

13. The trimming implement of claim 11, wherein said comb is attached to said shaft and teeth of said comb extend beyond an edge of said blade.

14. A trimmer integrated with a handle of a shaving implement, said trimmer comprising:
a reciprocatingly mounted blade; and
a comb mounted over said blade;
wherein said blade is capable of operating in a reciprocating motion.

15. The trimmer of claim 14, further comprising a power source operably connected to said blade to provide said reciprocating motion.

16. The trimmer of claim 15, wherein said power source is selected from the group consisting of direct current sources and alternating current sources.

17. The trimmer of claim 14, wherein said blade and said comb are mounted on a head pivotally attached to said handle.

18. The trimmer of claim 14, wherein said blade is mounted on said handle opposite an end of said handle at which a razor cartridge is mounted.
